(19) United States
(12) Patent Application Publication
(10) Pub. No.: US 2026/0006555 A1
(43) Pub. Date: Jan. 1, 2026

(54) TDLS BROADCAST TARGET WAKE TIME OPERATION

(71) Applicant: Samsung Electronics Co., Ltd., Suwon-si (KR)

(72) Inventors: Rubayet Shafin, Allen, TX (US); Yue Qi, Plano, TX (US); Boon Loong Ng, Plano, TX (US); Peshal Nayak, Plano, TX (US); Vishnu Vardhan Ratnam, Plano, TX (US)

(21) Appl. No.: 19/234,130

(22) Filed: Jun. 10, 2025

Related U.S. Application Data
(60) Provisional application No. 63/666,554, filed on Jul. 1, 2024.
(60) Provisional application No. 63/668,722, filed on Jul. 8, 2024.

(51) Int. Cl. H04W 52/02; H04W 76/14; H04W 84/12

(52) U.S. Cl. CPC H04W 52/0235; H04W 76/14; H04W 84/12

(57) ABSTRACT

A first station (STA) in a wireless network comprises a memory and a processor coupled to the memory. The first STA receives from an associated access point (AP), a beacon frame or a probe response frame that indicates a number of target beacon transmission times (TBTTs). The first STA transmits, to a second STA, a tunneled direct link setup (TDLS) broadcast target wake time (TWT) request frame when the first STA intends to transmit one or more frames to the second STA over a TDLS link during a TWT service period corresponding to a broadcast TWT schedule. The first STA receives, from the second STA, a TDLS broadcast TWT response frame accepting the request. The second STA is expected to be in an awake state during one or more TWT service periods corresponding to the broadcast TWT schedule until the number of TBTTs indicated by the AP.

### CROSS REFERENCE TO RELATED APPLICATION(S)

This application claims benefit of U.S. Provisional Application No. 63/666,554, entitled “TDLS BROADCAST TWT OBSERVANCE TERMINATION,” filed on Jul. 1, 2024; and U.S. Provisional Application No. 63/668,722, entitled “BROADCAST TWT SCHEDULE ENDING FOR TDLS LINKS,” filed on Jul. 8, 2024, in the United States Patent and Trademark Office, all of which are hereby incorporated by reference in their entirety.

### TECHNICAL FIELD

This disclosure relates generally to a wireless communication system, and more particularly to, for example, but not limited to, tunneled direct link setup (TDLS) target wake time (TWT) operation in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and protocol for terminating a tunneled direct link setup (TDLS) broadcast (B)-target wake time (TWT) schedule transmission.

An aspect of the disclosure provides a first station (STA) for facilitating communication in a wireless network. The first STA comprises a memory and a processor coupled to the memory. The processor is configured to cause receiving from an access point (AP) associated with the first STA, a beacon frame or a probe response frame that indicates a number of target beacon transmission times (TBTTs). The processor is further configured to cause transmitting, to a second STA, a tunneled direct link setup (TDLS) broadcast target wake time (TWT) request frame when the first STA intends to transmit one or more frames to the second STA over a TDLS link established between the first STA and the second STA during a TWT service period corresponding to a broadcast TWT schedule, wherein the first STA is a member of the broadcast TWT schedule. The processor is further configured to cause receiving, from the second STA, a TDLS broadcast TWT response frame indicating acceptance of the request of the TDLS broadcast TWT request frame. The second STA is expected to be in an awake state during one or more TWT service periods corresponding to the broadcast TWT schedule until the number of TBTTs indicated by the AP.

In an embodiment, the number of TBTTs is indicated in a broadcast TWT persistence subfield of a broadcast TWT parameter set field corresponding to the broadcast TWT schedule in the beacon frame or the probe response frame.

In an embodiment, the number of TBTTs is equal to a value in the broadcast TWT persistence subfield plus 1.

In an embodiment, the processor is further configured to cause advertising a capabilities element indicating that the first STA supports TDLS operation with broadcast TWT.

In an embodiment, the broadcast TWT schedule is identified by a broadcast TWT ID subfield in a TWT information extension element in the TDLS broadcast TWT request frame.

In an embodiment, a value of a broadcast TWT ID subfield in a TWT information extension element in the TDLS broadcast TWT response frame is identical to a value of the broadcast TWT ID subfield in the TWT information extension element in the TDLS broadcast TWT request frame.

In an embodiment, the second STA is expected to be in the awake state during the one or more TWT service periods corresponding to the broadcast TWT schedule until the number of TBTTs indicated by the AP reaches zero.

An aspect of the disclosure provides a first STA for facilitating communication in a wireless network. The first STA comprises a memory and a processor coupled to the memory. The processor is configured to cause receiving, from an AP associated with the first STA, a beacon frame or a probe response frame that indicates a number of TBTTs. The processor is further configured to cause receiving, from a second STA, a TDLS broadcast TWT request frame indicating that the second STA intends to transmit one or more frames to the first STA over a TDLS link established between the first STA and the second STA during a TWT service period corresponding to a broadcast TWT schedule, wherein the second STA is a member of the broadcast TWT schedule. The processor is further configured to cause transmitting, to the second STA, a TDLS broadcast TWT response frame indicating acceptance of the request of the TDLS broadcast TWT request frame. The processor is further configured to cause staying in an awake state during one or more TWT service periods corresponding to the broadcast TWT schedule until the number of TBTTs indicated by the AP.

In an embodiment, the number of TBTTs is indicated in a broadcast TWT persistence subfield of a broadcast TWT parameter set field corresponding to the broadcast TWT schedule in the beacon frame or the probe response frame.

In an embodiment, the number of TBTTs is equal to a value in the broadcast TWT persistence subfield plus 1.

In an embodiment, the processor is further configured to cause advertising a capabilities element indicating that the first STA supports TDLS operation with broadcast TWT.

In an embodiment, the broadcast TWT schedule is identified by a broadcast TWT ID subfield in a TWT information extension element in the TDLS broadcast TWT request frame.

In an embodiment, a value of a broadcast TWT ID subfield in a TWT information extension element in the TDLS broadcast TWT response frame is identical to a value of the broadcast TWT ID subfield in the TWT information extension element in the TDLS broadcast TWT request frame.

In an embodiment, the staying in an awake state during one or more TWT service periods comprises staying in the awake state during the one or more TWT service periods until the number of TBTTs reaches zero.

An aspect of the disclosure provides a method performed by a first STA. The method comprises receiving, from an AP associated with the first STA, a beacon frame or a probe response frame that indicates a number of TBTTs. The method further comprises transmitting, to the second STA, a TDLS broadcast TWT request frame when the first STA intends to transmit one or more frames to the second STA over a TDLS link established between the first STA and the second STA during a TWT service period corresponding to a broadcast TWT schedule, wherein the first STA is a member of the broadcast TWT schedule. The method further comprises receiving, from the second STA, a TDLS broadcast TWT response frame indicating acceptance of the request of the TDLS broadcast TWT request frame. The second STA is expected to be in an awake state during the one or more TWT service periods corresponding to the broadcast TWT schedule until the number of TBTTs indicated by the AP.

In an embodiment, the number of TBTTs is indicated in a broadcast TWT persistence subfield of a broadcast TWT parameter set field corresponding to the broadcast TWT schedule in the beacon frame or the probe response frame.

In an embodiment, the number of TBTTs is equal to a value in the broadcast TWT persistence subfield plus 1.

In an embodiment, the method further comprises advertising a capabilities element indicating that the first STA supports TDLS operation with broadcast TWT.

In an embodiment, the broadcast TWT schedule is identified by a broadcast TWT ID subfield in a TWT information extension element in the TDLS broadcast TWT request frame.

In an embodiment, a value of a broadcast TWT ID subfield in a TWT information extension element in the TDLS broadcast TWT response frame is identical to a value of the broadcast TWT ID subfield in the TWT information extension element in the TDLS broadcast TWT request frame.

### BRIEF DESCRIPTION OF THE DRAWINGS

FIG. 1 illustrates an example of a wireless network in accordance with an embodiment of this disclosure.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example TDLS communication in accordance with an embodiment.

FIG. 6 shows an example unavailability of a STA in accordance with an embodiment.

FIG. 7 shows an example TWT Information Extension element in accordance with an embodiment.

FIG. 8 shows an example Control field in accordance with an embodiment.

FIG. 9 shows an example B-TWT Info field in accordance with an embodiment.

FIG. 10 shows an example B-TWT Info field in accordance with an embodiment.

FIG. 11 shows an example B-TWT Setup in accordance with an embodiment.

FIG. 12 shows an example TDLS B-TWT schedule in accordance with an embodiment.

FIG. 13 shows another example TDLS B-TWT schedule in accordance with an embodiment.

FIG. 14 shows another example TDLS B-TWT schedule in accordance with an embodiment.

FIG. 15 shows an example B-TWT process in accordance with an embodiment.

FIG. 16 shows another example B-TWT process in accordance with an embodiment.

FIG. 17 shows an example process for indicating TDLS B-TWT termination or end time in accordance with an embodiment.

FIG. 18 shows another example process for indicating TDLS B-TWT termination or end time in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

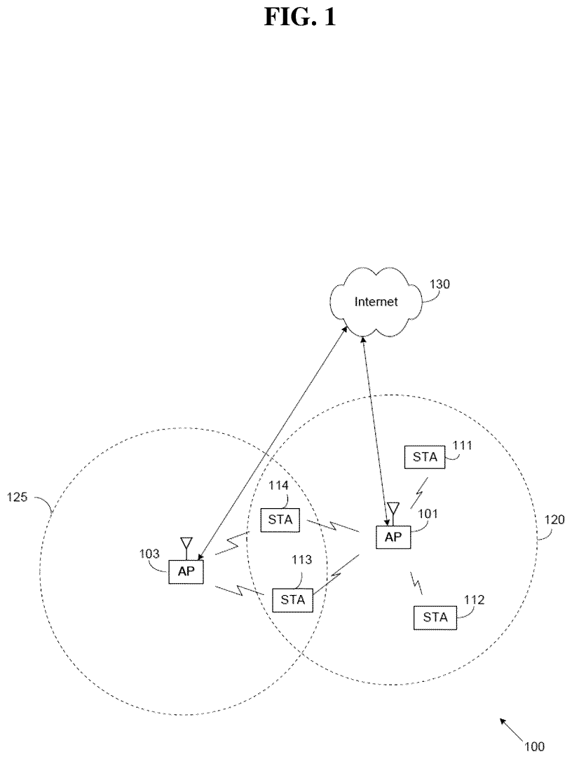

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

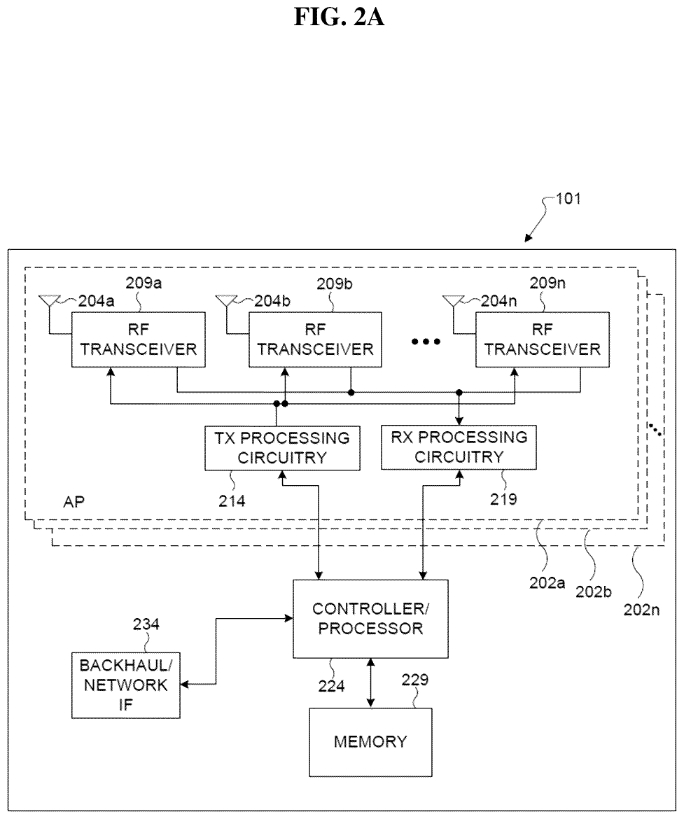

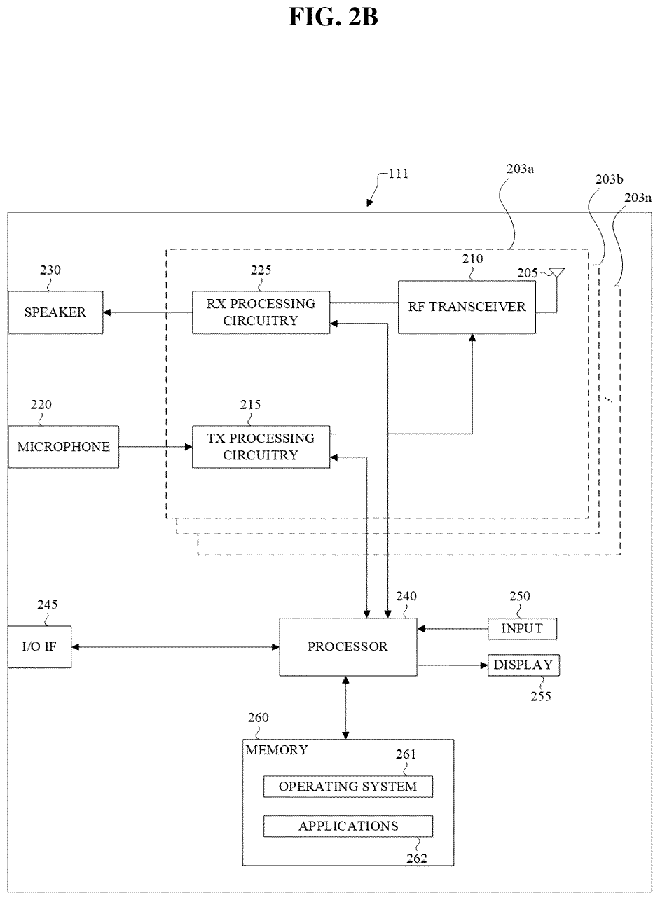

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

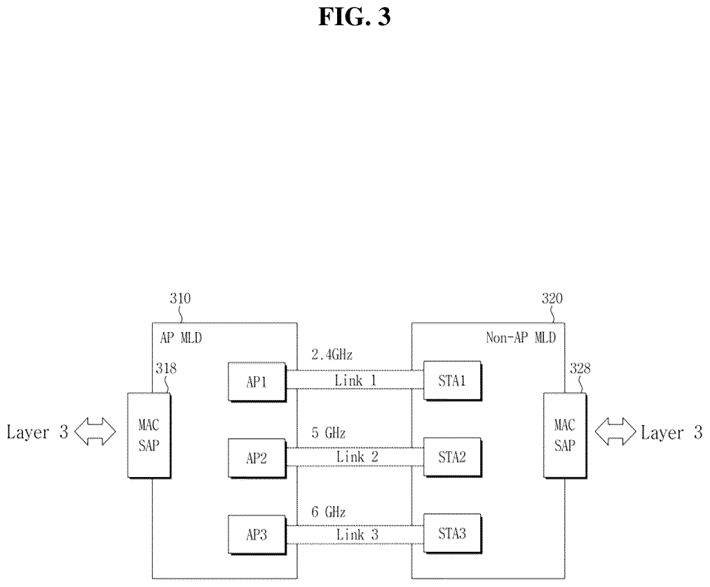

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310.

The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D6.0, “Wireless LAN Medium Access Control (MAC) and Physical Layer (PHY) Specifications.”

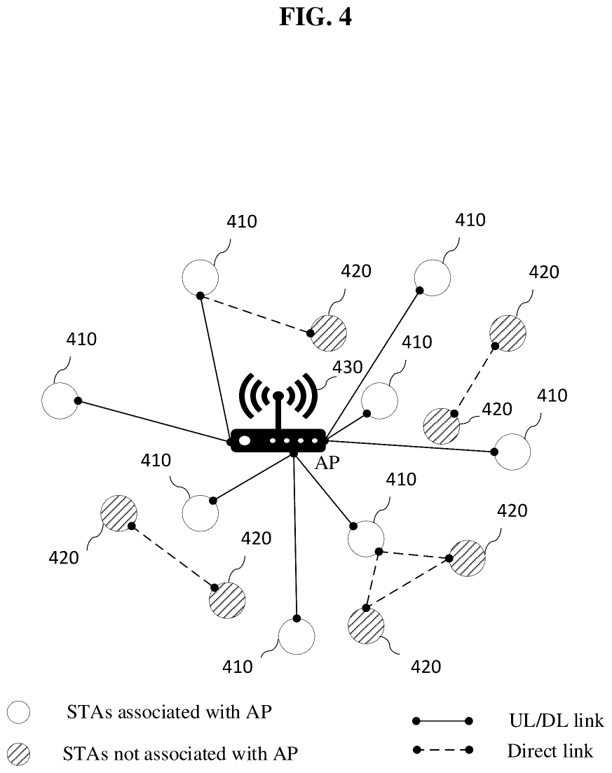

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Restricted target wake time (TWT) (R-TWT) operation is another key feature introduced in IEEE 802.11be standards with a view to providing better support for latency sensitive applications. R-TWT offers a protected service period (SP) for its member STAs by sending Quiet elements to other STAs in the BSS which are not a member of the R-TWT schedule, where the Quiet interval corresponding to the Quiet element overlaps with the initial portion of the restricted TWT SP. Hence it gives more channel access opportunities for the R-TWT member scheduled STAs, which definitely helps latency-sensitive traffic flow.

When a first STA becomes a member of a first R-TWT schedule, if the first STA has formed a tunneled direct link setup (TDLS) direct link with a second STA, there can exist a number of issues related to the operations of R-TWT and TDLS for the first STA.

During an R-TWT SP, a first STA can attempt to transmit a frame to a second STA over a TDLS direct link, if a first R-TWT schedule allows for the first STA to perform P2P communication during the R-TWT SP corresponding to the first R-TWT schedule. However, the second STA can miss the frame if the second STA is unavailable because of, for example, a power-saving operation of the second STA (the second STA can be in a doze state, or otherwise unavailable, when the frame is transmitted by the first STA during the R-TWT SP).

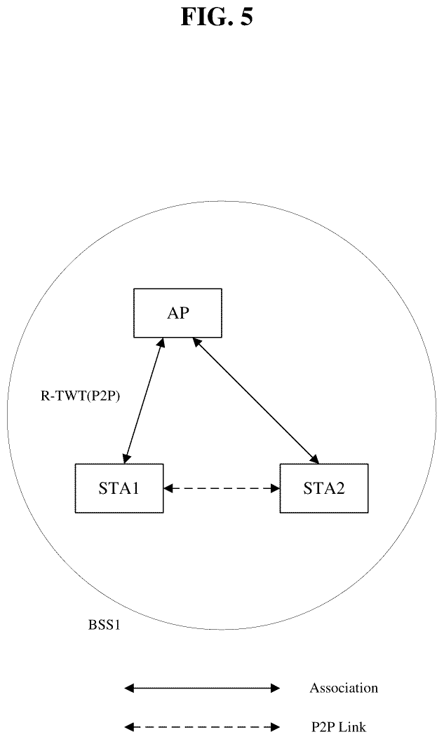

FIG. 5 shows an example TDLS communication in accordance with an embodiment. The communication depicted in FIG. 5 is for explanatory and illustration purposes. FIG. 5 does not limit the scope of this disclosure to any particular implementation.

Referring to FIG. 5, AP, STA1 and STA2 belong to a basic service set (BSS), BSS1. The AP is associated with the STA1 and the STA2. The STA1 and the STA2 have formed a TDLS direct link (a P2P link) between them. The STA1 is a member of an R-TWT schedule for P2P communication, including P2P communication with the STA2 over the STA1's and the STA2's P2P link.

In FIG. 5, during the R-TWT SP, the STA1 may attempt to transmit to the STA2. However, at the time the STA1 attempts to transmit to the STA 2, the STA2. For example, the STA2 may be in a doze state, and hence miss the frames transmitted by STA1 during the R-TWT SP.

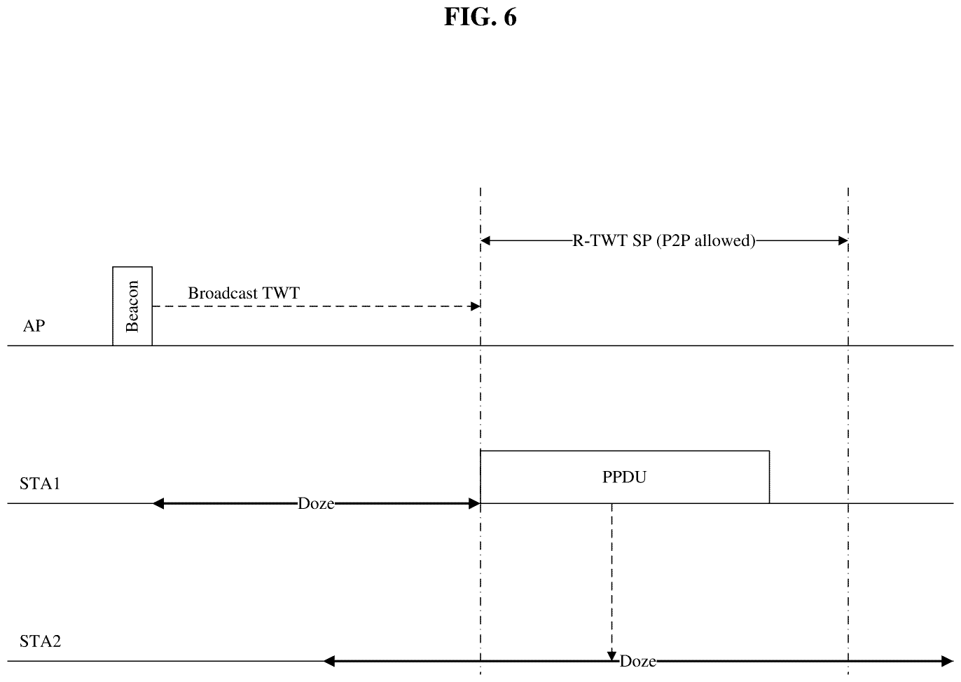

FIG. 6 shows an example unavailability of a STA in accordance with an embodiment. The unavailability depicted in FIG. 6 is for explanatory and illustration purposes. FIG. 6 does not limit the scope of this disclosure to any particular implementation.

Referring to FIG. 6, AP, STA1 and STA2 belong to a BSS. The AP is associated with the STA1 and the STA2. The STA1 and the STA2 have formed a TDLS direct link (a P2P link) between them. The STA1 is a member of an R-TWT schedule for P2P communication, including P2P communication with the STA2. The AP transmits a Beacon frame for a Broadcast TWT (B-TWT). Prior to a first R-TWT SP of the R-TWT schedule, the STA1 and the STA2 are in a Doze state. Subsequently, the STA1 switches to an Awake state once the R-TWT SP begins. The STA1 transmits, to the STA2, a PHY protocol data unit (PPDU). The STA2, however, remains in the Doze state and unavailable. The STA2 does not receive the PPDU as a result of the STA2's unavailability during the R-TWT SP.

A TDLS peer STA, such as the STA1 in FIG. 6, may transmit a TDLS Broadcast TWT Request frame to another TDLS peer STA if the TDLS peer STA is a member of a B-TWT schedule and the TDLS peer STA intends to transmit frames to the other TDLS peer STA over a TDLS direct link during a TWT SP corresponding to the B-TWT schedule. The transmission of the TDLS Broadcast TWT Request frame may require that the TDLS peer STA set the TDLS Broadcast TWT Support field in the Extended Capabilities element to 1, where the B-TWT schedule is identified by the Broadcast TWT ID subfield in the TWT Information Extension element in the TDLS Broadcast TWT Request frame. The TDLS peer STA advertises that the TDLS peer STA supports TDLS operation with broadcast TWT when setting the Extended Capabilities element to 1. The other TDLS peer STA may transmit a TDLS Broadcast TWT Response frame with a status code SUCCESS in response to receiving the TDLS Broadcast TWT Request frame. The transmission of the TDLS Broadcast TWT Response frame with the status code SUCCESS indicates that the other TDLS peer STA is expected to be in an awake state during the TWT SPs corresponding to the B-TWT schedule. In the TDLS Broadcast TWT Response frame, the Broadcast TWT ID subfield value in the TWT Information Extension element is the same as that in TDLS Broadcast TWT Request frame.

Currently, there is no mechanism to indicate the end of a TDLS B-TWT schedule. In the case where two TDLS peer STAs establish a TDLS B-TWT schedule as a power saving mechanism between the two TDLS peer STAs, there is no way to indicate when the power saving schedule between the TDLS peer STA ends or is terminated. Therefore, there is a requirement for such a mechanism.

This disclosure provides a mechanism and framework for terminating the observance time of a TDLS B-TWT schedule as a power saving mechanism between two TDLS peer STAs.

In an embodiment, a first STA can send a TDLS Broadcast TWT Request frame to a second STA and include a B-TWT schedule information. The first STA can indicate in the B-TWT schedule information how long the first STA expects the second STA to stay awake for during B-TWT SPs corresponding to a B-TWT schedule.

In an embodiment, the first STA can indicate in a B-TWT schedule information a time when the TDLS B-TWT schedule operation between the two TDLS peer STAs ends.

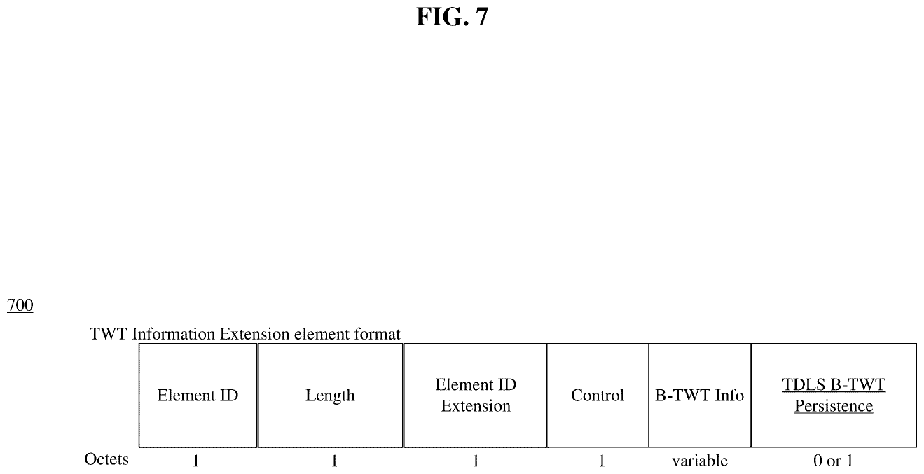

In an embodiment, an end time or termination time for a TDLS B-TWT schedule operation between two TDLS peer STAs can be expressed in terms of target beacon transmission time (TBTT). In this regard, a possible format of the TWT Information Extension element including the TDLS B-TWT Persistence field may be used as shown in FIG. 7.

FIG. 7 shows an example TWT Information Extension element 700 in accordance with an embodiment. The example depicted in FIG. 7 is for explanatory and illustration purposes. FIG. 7 does not limit the scope of this disclosure to any particular implementation.

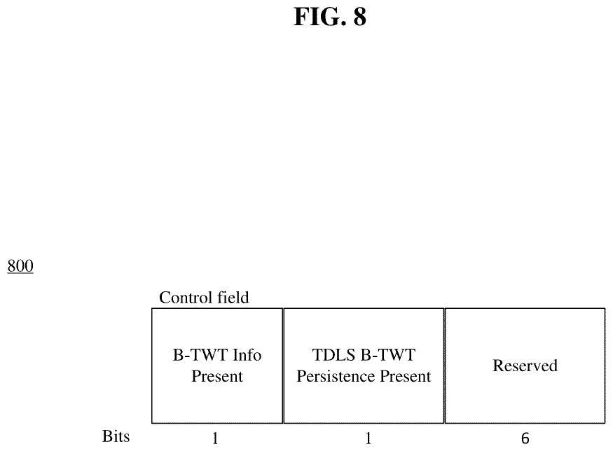

Referring FIG. 7, the TWT Information Extension element 700 includes an Element ID field, a Length field, an Element ID Extension field, a Control field, a B-TWT Info field and a TDLS B-TWT Persistence field. The Element ID and the Element ID Extension field include information to identify the element 700. The Length field indicates a length of the TWT Information Extension element. The Control field may include a B-TWT Info Present subfield, a TDLS B-TWT Persistence Present subfield, and Reserved bits, as shown in FIG. 8. The B-TWT Info field identifies a B-TWT schedule advertised by the AP. The TDLS B-TWT Persistence field indicates the number of TBTTs during which the B-TWT SPs are to be followed by the TDLS peer STA receiving the element 700. In an embodiment, when the TDLS B-TWT Persistence field has a value of 255, the TDLS B-TWT Persistence field indicates that the persistence value of the B-TWT schedule for the TDLS direct link is the same as the persistence value advertised by the associated AP for the same schedule.

The presence of the TDLS B-TWT Persistence field can be indicated in the Control field of the TWT Information Extension element 700. A possible format of the Control field is shown in FIG. 8.

FIG. 8 shows an example Control field 800 in accordance with an embodiment. The example depicted in FIG. 8 is for explanatory and illustration purposes. FIG. 8 does not limit the scope of this disclosure to any particular implementation.

Referring to FIG. 8, the Control field 800 includes a B-TWT Info Present subfield, a TDLS B-TWT Persistence Present subfield and Reserved bits. The B-TWT Info Present subfield indicates the presence of the B-TWT Info field in the TWT Information Extension element 700. In an embodiment, the B-TWT Info field is present if the B-TWT Info Present field is set to 1, otherwise the B-TWT Info is not present. The TDLS B-TWT Persistence Present subfield indicates whether or not the TDLS B-TWT Persistence field is present in the TWT Information Extension element. The B-TWT Persistence Present subfield indicates that the TDLS B-TWT Persistence field is present in the TWT Information Extension element if the TDLS B-TWT Persistence Present subfield is set to 1, otherwise the TDLS B-TWT Persistence field is not present in the TWT Information Extension element.

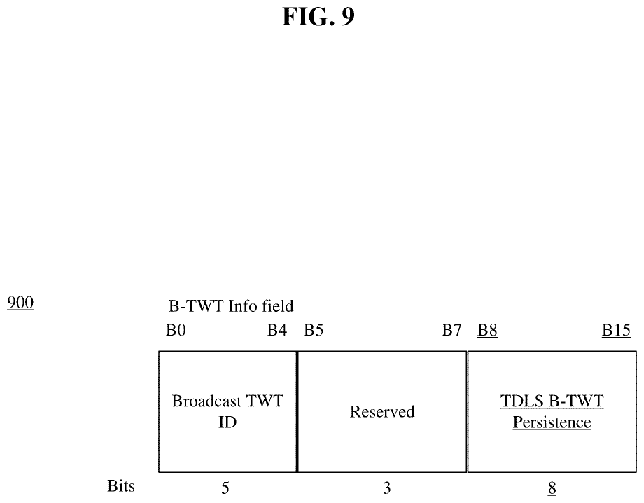

In an embodiment, the TDLS B-TWT Persistence field can be present in the B-TWT Info field in the TWT Information Extension element as a TDLS B-TWT Persistence subfield. The possible format of the B-TWT Info field is shown in FIG. 9.

FIG. 9 shows an example B-TWT Info field 900 in accordance with an embodiment. The example depicted in FIG. 9 is for explanatory and illustration purposes. FIG. 9 does not limit the scope of this disclosure to any particular implementation.

Referring to FIG. 9, the B-TWT Info field 900 includes a Broadcast TWT ID subfield, a TDLS B-TWT Persistence subfield, and Reserved bits. The Broadcast TWT ID subfield identifies a B-TWT schedule advertised by the AP. The TDLS B-TWT Persistence subfield indicates the number of TBTTs during which the B-TWT SPs are to be followed by the TDLS peer STA receiving the element. In an embodiment, when the TDLS B-TWT Persistence subfield has a value of 255, the TDLS B-TWT Persistence subfield indicates that the persistence value of the B-TWT schedule for the TDLS direct link is the same as the persistence value advertised by the associated AP for the same schedule.

In an embodiment, a first STA can indicate how long the first STA expects the second STA to remain awake during the B-TWT SPs corresponding to the B-TWT schedule when the first STA transmits a TDLS Broadcast TWT Response frame to the second STA and includes B-TWT schedule information.

In an embodiment, a first STA, which is a TDLS peer STA, can indicate a time when the TDLS Broadcast TWT schedule operation between the first STA and another TDLS peer STA ends when the first STA transmits a TDLS Broadcast TWT Response frame to the second STA and includes B-TWT schedule information.

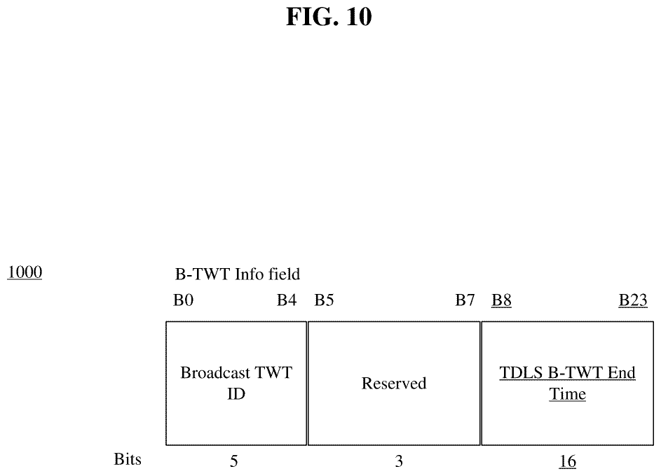

The end time of the TDLS B-TWT schedule can be indicated in the TWT Information Extension element. For example, a TDLS B-TWT End Time field can be included in the B-TWT Info field as shown in FIG. 10.

FIG. 10 shows an example B-TWT Info field 1000 in accordance with an embodiment. The example depicted in FIG. 10 is for explanatory and illustration purposes. FIG. 10 does not limit the scope of this disclosure to any particular implementation.

Referring to FIG. 10, the B-TWT Info field 1000 includes a Broadcast TWT ID subfield, a TDLS B-TWT End Time subfield, and Reserved bits. The Broadcast TWT ID subfield identifies a B-TWT schedule advertised by the AP. The TDLS B-TWT End Time subfield includes a positive unsigned integer corresponding to a time synchronizing function (TSF) time indicating when the TDLS B-TWT schedule between the two TDLS peer STAs ends. In an embodiment, the TDLS peer STA receiving the frame is not required to switch to an awake state for communications over the TDLS direct link. The TDLS B-TWT End Time subfield is 2 octet long (16 bits long) with the lowest bits of the 2 octets corresponding to bit 10 of the relevant TSF value.

In an embodiment, a TDLS peer STA may transmit a TDLS Broadcast TWT Request frame to another TDLS peer STA if the TDLS peer STA is a member of a B-TWT schedule and the TDLS peer STA intends to transmit frames to the other TDLS peer STA over a TDLS direct link during a TWT SP corresponding to the B-TWT schedule. The transmission of the TDLS Broadcast TWT Request frame may require that the TDLS peer STA set the TDLS Broadcast TWT Support field in the Extended Capabilities element to 1. The B-TWT schedule is identified by the Broadcast TWT ID subfield in the TWT Information Extension element in the TDLS Broadcast TWT Request frame. The other TDLS peer STA may transmit a TDLS Broadcast TWT Response frame with a status code SUCCESS in response to receiving the TDLS Broadcast TWT Request frame. The transmission of the TDLS Broadcast TWT Response frame with the status code SUCCESS indicates that the other TDLS peer STA is expected to switch to an awake state during the TWT SPs corresponding to the B-TWT schedule until the number of TBTTs indicated in the TDLS B-TWT Persistence field. After the value of TBTT indicated in the TDLS B-TWT Persistence field reaches zero, the other TDLS peer STA is no longer expected to switch to an awake state during the broadcast TWT SPs corresponding to the broadcast TWT schedule.

In an embodiment, a TDLS B-TWT Persistence field value in a TWT Information Extension element of a TDLS Broadcast TWT Response frame can be the same as that in the TDLS Broadcast TWT Request frame.

In an embodiment, a TDLS Broadcast TWT Support field in an Extended Capabilities element field is reserved for use when the element is transmitted by an AP.

In an embodiment, a STA sets the TDLS Support field to 1 if the STA set the TDLS Broadcast TWT Support field to 1. The TDLS Broadcast TWT operation can be valid if the transmitting STA also supports the TDLS operation.

In an embodiment, a STA can be unavailable for communication when the STA is expected to be in an awake state.

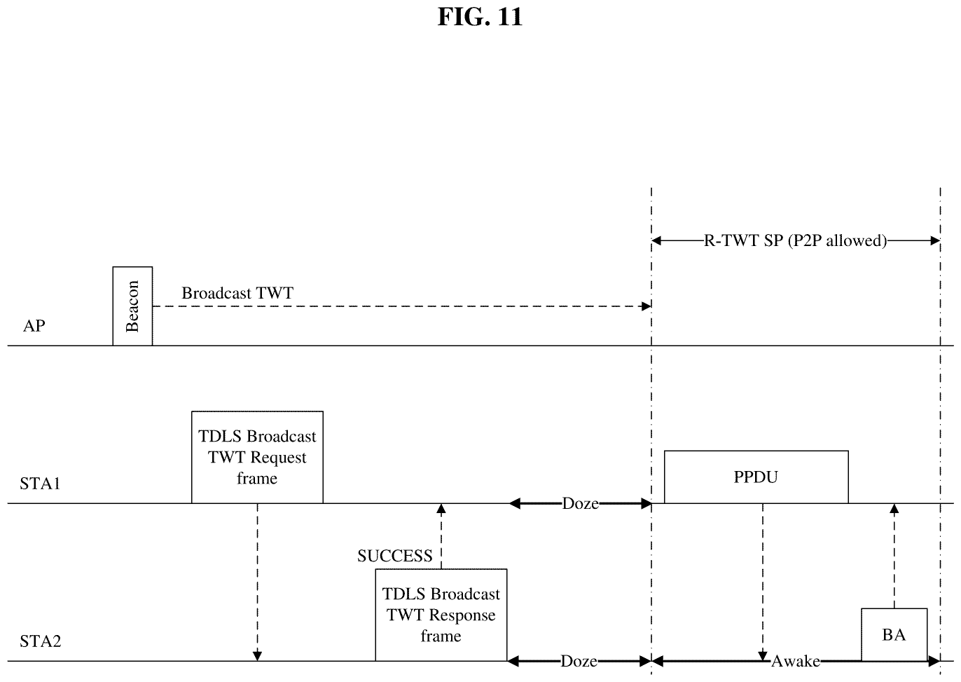

FIG. 11 shows an example B-TWT Setup in accordance with an embodiment. The example depicted in FIG. 11 is for explanatory and illustration purposes. FIG. 11 does not limit the scope of this disclosure to any particular implementation.

Referring to FIG. 11, AP, STA1 and STA2 belong to a BSS. The AP is associated with the STA1 and the STA2. The STA1 and the STA2 have formed a TDLS direct link (a P2P link) between them. The STA1 is a member of an R-TWT schedule for P2P communication, including P2P communication with the STA2. The AP transmits a Beacon frame for a Broadcast TWT. Prior to a first R-TWT SP of the R-TWT schedule, the STA1 transmits, to the STA2, a TDLS Broadcast TWT Request frame requesting to setup a B-TWT schedule as a power saving mechanism between the STA 1 and the STA2. In response, the STA2 transmits, to the STA1, a TDLS Broadcast TWT Response frame accepting the request with an indication of “SUCCESS.” Subsequently, the STA1 switches to a Doze state, becoming unavailable. The STA2 switches to a Doze state becoming unavailable. The STA1 switches to an Awake state once the B-TWT SP begins. The STA2 switches to an Awake state once the B-TWT SP begins. Subsequently, the STA1 transmits, to the STA2, a PPDU for its P2P communication. In response, the STA2 transmits, to the STA1, a block acknowledgement (BA).

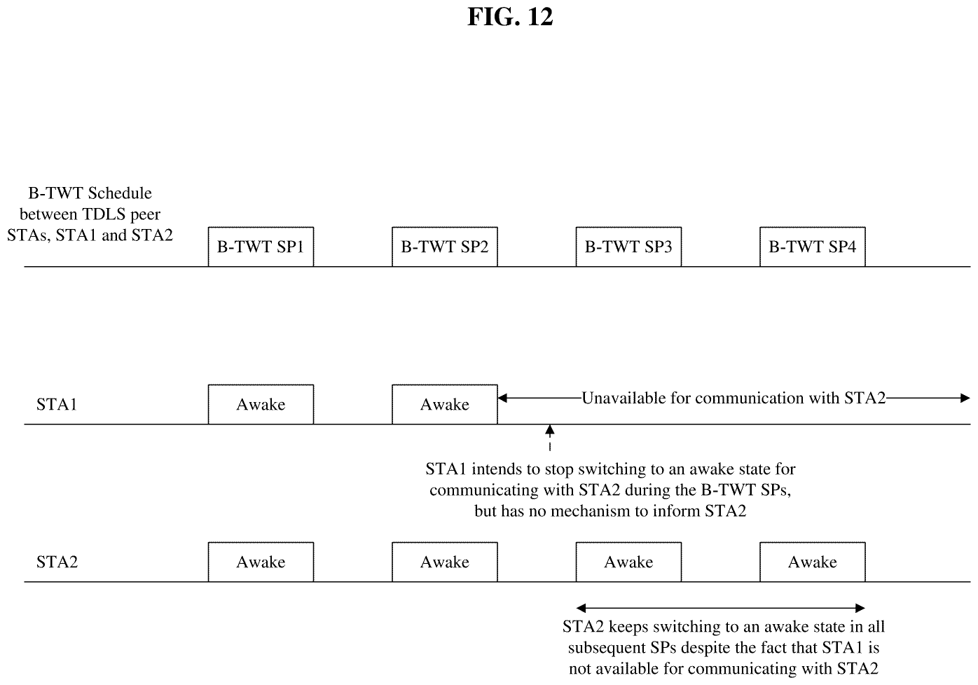

FIG. 12 shows an example TDLS B-TWT schedule in accordance with an embodiment. The example depicted in FIG. 12 is for explanatory and illustration purposes. FIG. 12 does not limit the scope of this disclosure to any particular implementation.

Referring to FIG. 12, a B-TWT Schedule between TDLS peer STAs includes B-TWT SP1, B-TWT SP2, B-TWT SP3 and B-TWT SP4. STA1 and STA2 are TDLS peer STAs. The STA1 and the STA2 are members of the B-TWT Schedule. The STA1 switches to an Awake state during B-TWT SP1 and B-TWT SP2. The STA2 switches to an Awake state during B-TWT SP1 and B-TWT SP2. After B-TWT SP2 ends, the STA1 intends to stop switching to an Awake state for communicating with the STA2 during the B-TWT SPs but has no mechanism to inform the STA2. As a result, the STA1 is unavailable for communication with the STA2 during B-TWT SP3 and B-TWT SP4. The STA2 switches to an Awake state during B-TWT SP3 and B-TWT SP4 despite the fact that the STA1 is unavailable for communication with the STA2. The STA1 being unavailable for communication when the STA2 switches to an awake state for communication with the STA1 causes inefficient power consumption by the STA2.

In an embodiment, a TDLS peer STA is expected to switch to an awake state during B-TWT SPs corresponding to a B-TWT schedule for the number of TBTTs indicated by an associated AP in a Broadcast TWT Persistence field. The Broadcast TWT Persistence field is included in a Broadcast TWT Parameter Set field corresponding to the B-TW schedule in a Beacon frame or a Probe Response frame. In an embodiment, the TDLS peer STA is expected to switch to an awake state during the B-TWT SPs corresponding to the B-TWT schedule until the associated AP explicitly terminates the B-TWT schedule.

In an embodiment, a TDLS peer STA is expected to switch to an awake state during B-TWT SPs corresponding to a B-TWT schedule until a Broadcast TWT Persistence field reaches zero. The Broadcast TWT Persistence field is included in a Broadcast TWT Parameter Set field corresponding to the B-TWT schedule in a Beacon frame or Probe Response frame. In an embodiment, the number of TWT SPs during which the other TWT peer STA is expected to switch to an awake state is equal to the value in the Broadcast TWT Persistence field plus 1. In an embodiment, the number of beacon intervals during which the TWT peer STA is expected to switch to an awake state is equal to the value in the Broadcast TWT Persistence field plus 1. In an embodiment, the TDLS peer STA may still keep switching to an awake state until the TBTT indicated in the Broadcast TWT Persistence field value, provided by an associated AP, even when another TDLS peer STA that requested the TDLS peer STA to switch to the awake state during the B-TWT SPs does not intend to switch to an awake state during the B-TWT SP for communication with the TDLS peer STA. The other TDLS STA may have terminated its membership from the B-TWT schedule with the AP earlier than the nominal schedule end time indicated by the AP in the Broadcast TWT Persistence field.

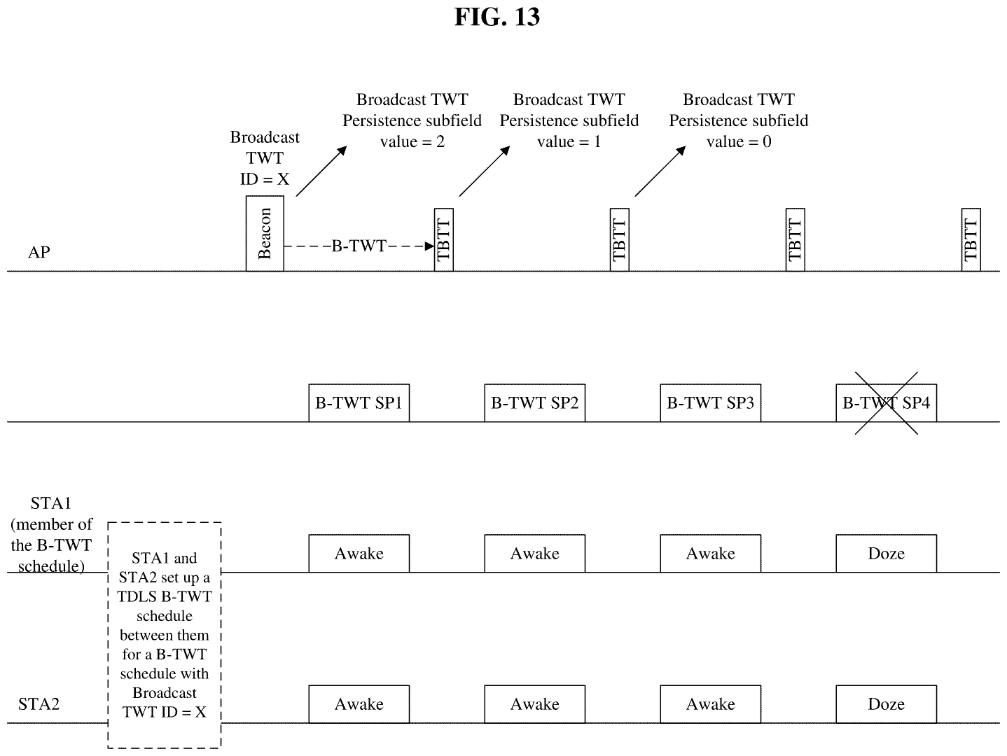

FIG. 13 shows another example TDLS B-TWT schedule in accordance with an embodiment. The example depicted in FIG. 13 is for explanatory and illustration purposes. FIG. 13 does not limit the scope of this disclosure to any particular implementation.

Referring to FIG. 13, AP is associated with STA1 and STA2. The STA1 is a member of a B-TWT schedule with B-TWT ID subfield is set to X provided by the AP. The STA1 and the STA2 set up a TDLS B-TWT schedule between them for the B-TWT schedule ID subfield is set to X. The AP transmits a Beacon frame for B-TWT schedule ID subfield is set to X with a Broadcast TWT Persistence subfield value set to 2. Subsequently, the STA1 switches to an Awake state during B-TWT SP1. Similarly, the STA2 switches to an Awake state during B-TWT SP1. After B-TWT SP1 ends, at a TBTT, the Broadcast TWT Persistence subfield value decrements to 1. Subsequently, the STA1 switches to an Awake state during B-TWT SP2. Similarly, the STA2 switches to an Awake state during B-TWT SP2. After B-TWT SP2 ends, at a TBTT, the Broadcast TWT Persistence subfield value is decremented to 0. Subsequently, the STA1 switches to an Awake state during B-TWT SP3. Similarly, the STA2 switches to an Awake state during B-TWT SP3. After B-TWT SP3 ends, the Broadcast TWT Persistence subfield is already at a value of 0, so the B-TWT schedule concludes and there is no B-TWT SP4. Subsequently, the STA1 switches to a Doze state during the time which a B-TWT SP4 would have occurred. Similarly, the STA2 switches to a Doze state during the time which a B-TWT SP4 would have occurred.

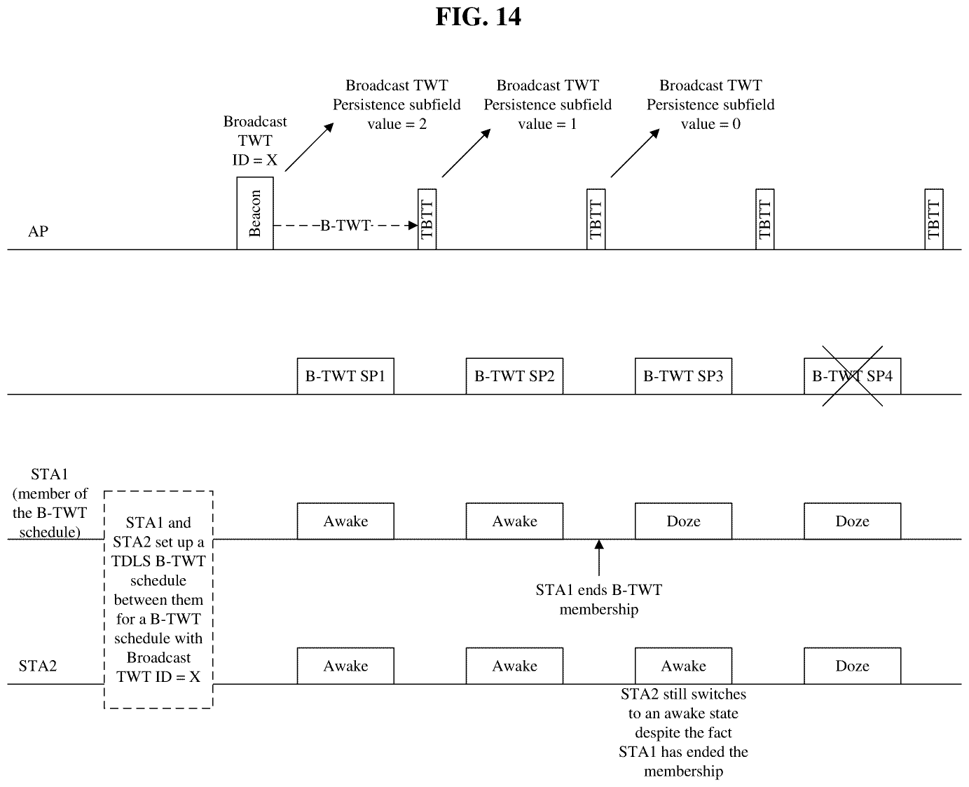

FIG. 14 shows another example TDLS B-TWT schedule in accordance with an embodiment. The example depicted in FIG. 14 is for explanatory and illustration purposes. FIG. 14 does not limit the scope of this disclosure to any particular implementation.

Referring to FIG. 14, AP is associated with STA1 and STA2. The STA1 is a member of a B-TWT schedule with B-TWT ID subfield set to X provided by the AP. The STA1 and the STA2 set up a TDLS B-TWT schedule between them for the B-TWT schedule ID subfield set to X. The AP transmits a Beacon frame for B-TWT schedule ID subfield set to X with a Broadcast TWT Persistence subfield value set to 2. Subsequently, the STA1 switches to an Awake state during B-TWT SP1. Similarly, the STA2 switches to an Awake state during B-TWT SP1. After B-TWT SP1 ends, at a TBTT, the Broadcast TWT Persistence subfield value decrements to 1. Subsequently, the STA1 switches to an Awake state during B-TWT SP2. Similarly, the STA2 switches to an Awake state during B-TWT SP2. After B-TWT SP2 ends, at a TBTT, the Broadcast TWT Persistence subfield value is decremented to 0. The STA1 ends B-TWT membership with the B-TWT schedule ID subfield set to X. Subsequently, the STA1 switches to a Doze state during B-TWT SP3 and is unavailable for communication with the STA2. The STA2 switches to an Awake state during B-TWT SP3 despite the fact that STA1 has ended the membership and is unavailable for communication. After B-TWT SP3 ends, the Broadcast TWT Persistence subfield is already at a value of 0, so the B-TWT schedule concludes and there is no B-TWT SP4. The STA1 switches to a Doze state during the time which a B-TWT SP4 would have occurred. Subsequently, the STA2 switches to a Doze state during the time which a B-TWT SP4 would have occurred.

In an embodiment, a TDLS peer STA may receive TDLS B-TWT termination time information from a Beacon frame, a Probe Response frame, an Association Response frame or a Reassociation Response frame.

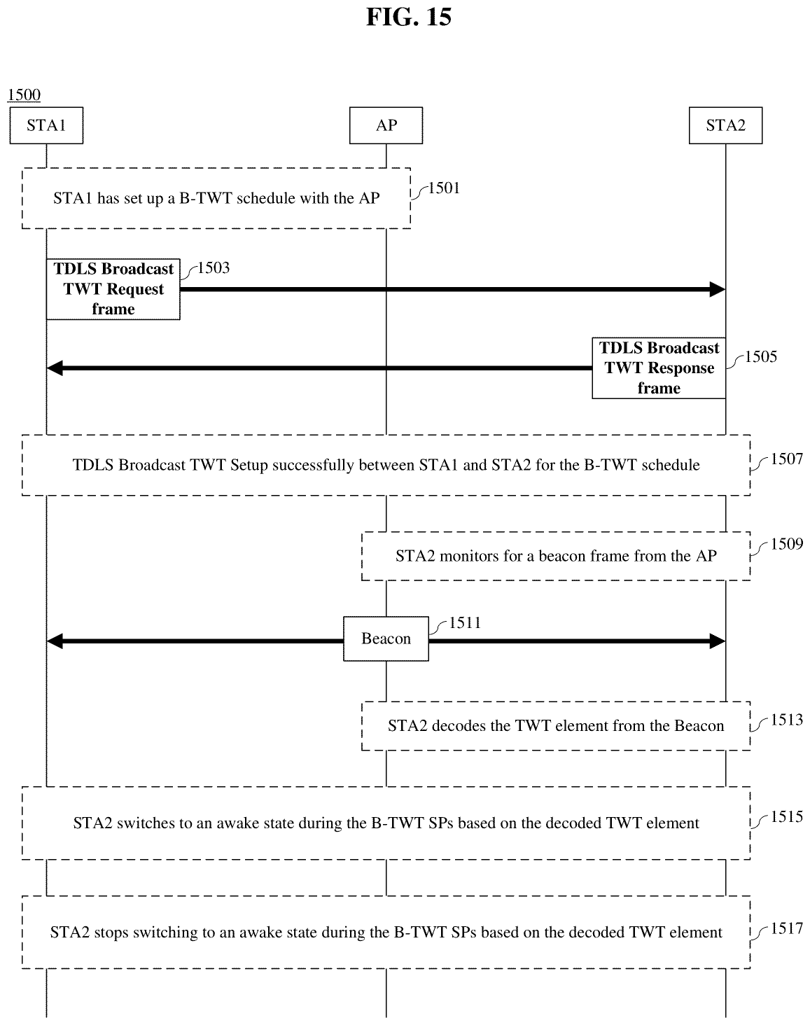

FIG. 15 shows an example B-TWT process 1500 in accordance with an embodiment. The example depicted in FIG. 15 is for explanatory and illustration purposes. FIG. 15 does not limit the scope of this disclosure to any particular implementation.

Referring to FIG. 15, the process 1500 begins at operation 1501. In operation 1501, a first STA successfully sets up a B-TWT schedule with an associated AP. The AP is associated with the STA1 and the STA2. The STA1 and the STA2 have a TDLS direct link between them. The STA1 has set up a B-TWT schedule with the AP corresponding to a B-TWT. The B-TWT schedule includes a Broadcast TWT ID. The Broadcast TWT ID subfield is set to X.

In operation 1503, the STA1 transmits, to the STA2, a TDLS Broadcast TWT Request frame requesting to establish a TDLS B-TWT schedule with the second STA. The TDLS Broadcast TWT Request frame includes a TWT Information Extension element. The TWT Information Extension element includes the Broadcast TWT ID subfield. The Broadcast TWT ID is set to X.

In operation 1505, the STA2 transmits, to the STA1, a TDLS Broadcast TWT Response frame indicating an acceptance of the request in the TDLS Broadcast TWT Request frame. The TDLS Broadcast TWT Response frame includes a TWT Information Extension element. The TWT Information Extension element includes the Broadcast TWT ID subfield. The Broadcast TWT ID subfield is set to X. The TDLS Broadcast TWT Response frame indicates “SUCCESS” as an acceptance of the request in the TDLS Broadcast TWT Request frame.

In operation 1507, the STA1 and the STA2 have successfully performed TDLS Broadcast TWT Setup for the B-TWT schedule. The B-TWT schedule subfield includes a Broadcast TWT ID subfield. The Broadcast TWT ID subfield is set to X.

In operation 1509, the STA2 monitors for a beacon frame transmitted by the AP.

In operation 1511, the AP transmits, to the STA1 and the STA2, a Beacon frame.

In operation 1513, the STA2 decodes the TWT element from the Beacon frame. The TWT element includes the Broadcast TWT Parameter Set field. The Broadcast TWT Parameter Set field corresponds to the B-TWT schedule. The Broadcast TWT element includes a B-TWT Info field. The B-TWT Info field includes a Broadcast TWT ID subfield. The Broadcast TWT ID subfield is set to X. The TWT Parameter Set field includes the Broadcast TWT Persistence subfield. The Broadcast TWT Persistence subfield is set to k.

In operation 1515, the STA2 switches to an awake state during the B-TWT SPs based on the decoded TWT element. The B-TWT SPs correspond to the B-TWT schedule with the value of the Broadcast TWT ID subfield set to X.

In operation 1517, the STA2 stops switching to an awake state during the B-TWT SPs based on the decoded TWT element. The STA2 stops switching after the (k+1)th SP. The STA1 and the STA2 can consider that the TDLS Broadcast TWT schedule is terminated between the STA1 and the STA2 for the schedule corresponding to the value of the Broadcast TWT ID subfield is set to X.

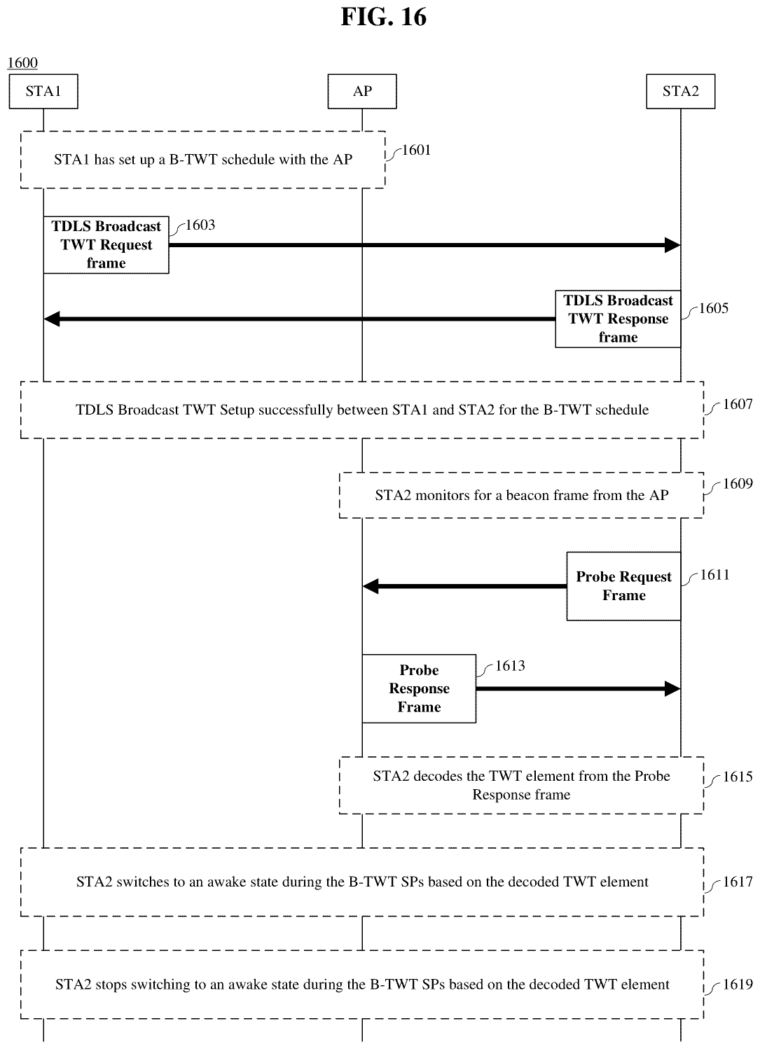

FIG. 16 shows another example B-TWT process in accordance with an embodiment. The operation depicted in FIG. 16 is for explanatory and illustration purposes. FIG. 16 does not limit the scope of this disclosure to any particular implementation.

Referring to FIG. 16, the process 1600 begins at operation 1601. In operation 1601, a first STA successfully sets up a B-TWT schedule with an associated AP. The AP is associated with the STA1 and the STA2. The STA1 and the STA2 have a TDLS direct link between them. The STA1 has set up a B-TWT schedule with the AP corresponding to a B-TWT. The B-TWT schedule includes a Broadcast TWT ID. The Broadcast TWT ID subfield is set to X.

In operation 1603, the STA1 transmits, to the STA2, a TDLS Broadcast TWT Request frame requesting to establish a TDLS B-TWT schedule with the second STA. The TDLS Broadcast TWT Request frame includes a TWT Information Extension element. The TWT Information Extension element includes the Broadcast TWT ID subfield. The Broadcast TWT ID is set to X.

In operation 1605, the STA2 transmits, to the STA1, a TDLS Broadcast TWT Response frame indicating an acceptance of the request in the TDLS Broadcast TWT Request frame. The TDLS Broadcast TWT Response frame includes a TWT Information Extension element. The TWT Information Extension element includes the Broadcast TWT ID subfield. The Broadcast TWT ID subfield is set to X. The TDLS Broadcast TWT Response frame indicates “SUCCESS” as an acceptance of the request in the TDLS Broadcast TWT Request frame.

In operation 1607, the STA1 and the STA2 have successfully performed TDLS Broadcast TWT Setup for the B-TWT schedule. The B-TWT schedule subfield includes a Broadcast TWT ID subfield. The Broadcast TWT ID subfield is set to X.

In operation 1609, the STA2 monitors for a beacon frame transmitted by the AP.

In operation 1611, the STA2 transmits, to the AP, a Probe Request frame requesting a B-TWT Parameter set.

In operation 1613, the AP transmits, to the STA2, a Probe Response frame including a TWT element.

In operation 1615, the STA2 decodes the TWT element from the Probe Response frame. The TWT element includes the Broadcast TWT Parameter Set field. The Broadcast TWT Parameter Set field corresponds to the B-TWT schedule. The Broadcast TWT element includes a B-TWT Info field. The B-TWT Info field includes a Broadcast TWT ID subfield. The Broadcast TWT ID subfield is set to X. The TWT Parameter Set field includes the Broadcast TWT Persistence subfield. The Broadcast TWT Persistence subfield is set to k.

In operation 1617, the STA2 switches to an awake state during the B-TWT SPs based on the decoded TWT element. The B-TWT SPs correspond to the B-TWT schedule with the value of the Broadcast TWT ID subfield set to X.

In operation 1619, the STA2 stops switching to an awake state during the B-TWT SPs based on the decoded TWT element. The STA2 stops switching after the (k+1)th SP. The STA1 and the STA2 can consider that the TDLS Broadcast TWT schedule is terminated between the STA1 and the STA2 for the schedule corresponding to the value of the Broadcast TWT ID subfield is set to X.

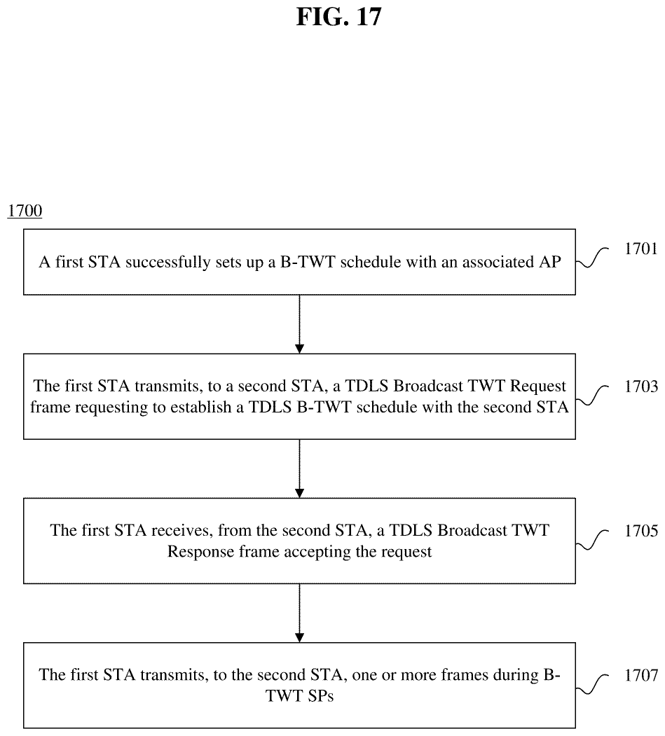

FIG. 17 shows an example process for indicating TDLS B-TWT termination or end time in accordance with an embodiment. The process depicted in FIG. 17 is for explanatory and illustration purposes. FIG. 17 does not limit the scope of this disclosure to any particular implementation.

Referring to FIG. 17, the process 1700 begins at operation 1701. In operation 1701, a first STA successfully sets up a B-TWT schedule with an associated AP. The B-TWT schedule has a corresponding Broadcast TWT ID subfield set to X.

In operation 1703, the first STA transmits to a second STA, a TDLS Broadcast TWT Request frame requesting to establish a TDLS B-TWT schedule with the second STA. The first STA has a P2P direct link with the second STA. The TDLS Broadcast TWT Request frame includes the Broadcast TWT Persistence subfield. The TDLS Broadcast TWT Request frame includes a Broadcast TWT ID subfield. The Broadcast TWT ID subfield is, for example, set to X.

In operation 1705, the first STA receives, from the second STA, a TDLS Broadcast TWT Response frame accepting the request. In an embodiment the TDLS Broadcast TWT Response frame accepts the request by indicating “SUCCESS.” The TDLS Broadcast TWT Response frame includes a Broadcast TWT ID subfield set to X.

In operation 1707, the first STA transmits, to the second STA, one or more frames during B-TWT SPs. The B-TWT SPs correspond to the B-TWT schedule. The first STA expects the second STA to switch to an awake state during the B-TWT SPs. In an embodiment, the second STA is expected to switch to the awake state for a duration based on a value of the Broadcast TWT Persistence subfield.

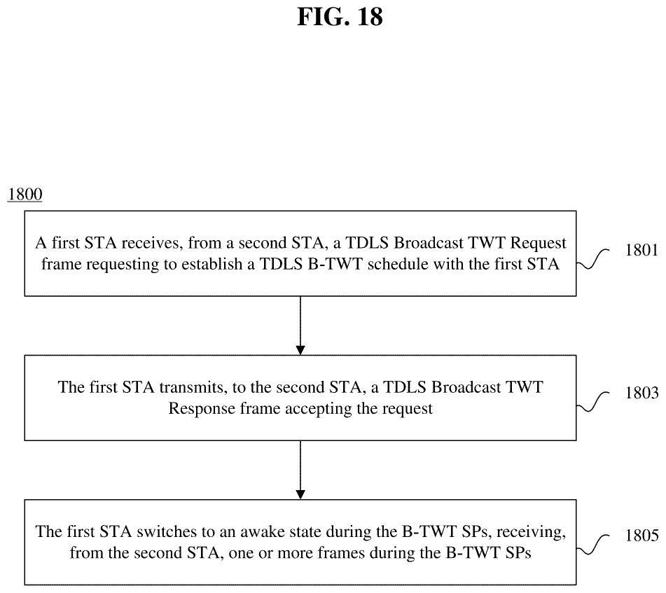

FIG. 18 shows another example process for indicating TDLS B-TWT termination or end time in accordance with an embodiment. The process depicted in FIG. 18 is for explanatory and illustration purposes. FIG. 18 does not limit the scope of this disclosure to any particular implementation.

Referring to FIG. 18, the process 1800 begins at operation 1801. In operation 1801, a first STA receives, from a second STA, a TDLS Broadcast TWT Request frame requesting to establish a TDLS B-TWT schedule with the first STA. The B-TWT schedule is set up between the first STA and an associated AP. The B-TWT schedule has a corresponding Broadcast TWT ID subfield set to X. The first STA has a P2P direct link with the second STA. The TDLS Broadcast TWT Request frame corresponds to a B-TWT schedule. The B-TWT schedule includes a TWT Persistence subfield. The TDLS Broadcast TWT Request frame includes a Broadcast TWT ID subfield. The Broadcast TWT ID subfield is, for example, set to X.

In operation 1803, the first STA transmits, to the second STA, a TDLS Broadcast TWT Response frame accepting the request. The TDLS Broadcast TWT Response frame accepts the request by indicating “SUCCESS.” The TDLS Broadcast TWT Response frame includes a Broadcast TWT ID subfield. The Broadcast TWT ID subfield is, for example, set to X.

In operation 1805, the first STA switches to an awake state during B-TWT SPs receiving, from the second STA, one or more frames during the B-TWT SPs. The B-TWT SPs correspond to the B-TWT schedule. In an embodiment, the first STA switches to an awake state for a duration based on a value of the Broadcast TWT Persistence subfield.

If a TDLS peer STA that is a member of a B-TWT schedule intends to transmit frames to another TDLS peer STA over a TDLS direct link during the TWT SP corresponding to the B-TWT schedule, then the TDLS peer STA may send a TDLS Broadcast TWT Request frame to the other TDLS peer STA if both of the TDLS peer STAs set the TDLS Broadcast TWT Support field in the Extended Capabilities element they transmit to 1, where the B-TWT schedule is identified by the Broadcast TWT ID subfield in the TWT Information Extension element in the TDLS Broadcast TWT Request frame. If the other TDLS peer STA, upon reception of the TDLS Broadcast TWT Request frame, responds by transmitting a TDLS Broadcast TWT Response frame with the status code SUCCESS, then the other TDLS peer STA is expected to be in an awake state during the TWT SPs corresponding to the B-TWT schedule until the number of TBTTs indicated in the TDLS B-TWT Persistence subfield. After the value of TBTT indicated in the TDLS B-TWT Persistence subfield reaches zero, the TDLS peer STA is no longer expected to be awake during the B-TWT SPs corresponding to the B-TWT schedule.

The disclosure provides mechanisms and protocols for efficient termination of a TDLS B-TWT schedule. This prevents devices performing TDLS B-TWT operations from consuming power unnecessarily. Devices can thereby save power during the TDLS B-TWT operations. This saving of power provides improving power efficiency of the TDLS B-TWT operations.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) for facilitating communication in a wireless network, comprising:
a memory; and
a processor coupled to the memory, the processor configured to cause:
receiving from an access point (AP) associated with the first STA, a beacon frame or a probe response frame that indicates a number of target beacon transmission times (TBTTs);
transmitting, to a second STA, a tunneled direct link setup (TDLS) broadcast target wake time (TWT) request frame when the first STA intends to transmit one or more frames to the second STA over a TDLS link established between the first STA and the second STA during a TWT service period corresponding to a broadcast TWT schedule, wherein the first STA is a member of the broadcast TWT schedule; and
receiving, from the second STA, a TDLS broadcast TWT response frame indicating acceptance of the request of the TDLS broadcast TWT request frame,
wherein the second STA is expected to be in an awake state during one or more TWT service periods corresponding to the broadcast TWT schedule until the number of TBTTs indicated by the AP.

2. The first STA of claim 1, wherein the number of TBTTs is indicated in a broadcast TWT persistence subfield of a broadcast TWT parameter set field corresponding to the broadcast TWT schedule in the beacon frame or the probe response frame.

3. The first STA of claim 1, wherein the number of TBTTs is equal to a value in the broadcast TWT persistence subfield plus 1.

4. The first STA of claim 1, wherein the processor is further configured to cause:
advertising a capabilities element indicating that the first STA supports TDLS operation with broadcast TWT.

5. The first STA of claim 1, wherein the broadcast TWT schedule is identified by a broadcast TWT ID subfield in a TWT information extension element in the TDLS broadcast TWT request frame.

6. The first STA of claim 5, wherein a value of a broadcast TWT ID subfield in a TWT information extension element in the TDLS broadcast TWT response frame is identical to a value of the broadcast TWT ID subfield in the TWT information extension element in the TDLS broadcast TWT request frame.

7. The first STA of claim 1, wherein the second STA is expected to be in the awake state during the one or more TWT service periods corresponding to the broadcast TWT schedule until the number of TBTTs indicated by the AP reaches zero.

8. A first station (STA) for facilitating communication in a wireless network, comprising:
a memory; and
a processor coupled to the memory, the processor configured to cause:
receiving, from an access point (AP) associated with the first STA, a beacon frame or a probe response frame that indicates a number of target beacon transmission times (TBTTs);
receiving, from a second STA, a tunneled direct link setup (TDLS) broadcast target wake time (TWT) request frame indicating that the second STA intends to transmit one or more frames to the first STA over a TDLS link established between the first STA and the second STA during a TWT service period corresponding to a broadcast TWT schedule, wherein the second STA is a member of the broadcast TWT schedule;
transmitting, to the second STA, a TDLS broadcast TWT response frame indicating acceptance of the request of the TDLS broadcast TWT request frame; and
staying in an awake state during one or more TWT service periods corresponding to the broadcast TWT schedule until the number of TBTTs indicated by the AP.

9. The first STA of claim 8, wherein the number of TBTTs is indicated in a broadcast TWT persistence subfield of a broadcast TWT parameter set field corresponding to the broadcast TWT schedule in the beacon frame or the probe response frame.

10. The first STA of claim 8, wherein the number of TBTTs is equal to a value in the broadcast TWT persistence subfield plus 1.

11. The first STA of claim 8, wherein the processor is further configured to cause:
advertising a capabilities element indicating that the first STA supports TDLS operation with broadcast TWT.

12. The first STA of claim 8, wherein the broadcast TWT schedule is identified by a broadcast TWT ID subfield in a TWT information extension element in the TDLS broadcast TWT request frame.

13. The first STA of claim 12, wherein a value of a broadcast TWT ID subfield in a TWT information extension element in the TDLS broadcast TWT response frame is identical to a value of the broadcast TWT ID subfield in the TWT information extension element in the TDLS broadcast TWT request frame.

14. The first STA of claim 8, wherein the staying in an awake state during one or more TWT service periods comprises staying in the awake state during the one or more TWT service periods until the number of TBTTs reaches zero.

15. A method performed by a first station (STA), the method comprising:
receiving, from an access point (AP) associated with the first STA, a beacon frame or a probe response frame that indicates a number of target beacon transmission times (TBTTs);
transmitting, to the second STA, a tunneled direct link setup (TDLS) broadcast target wake time (TWT) request frame when the first STA intends to transmit one or more frames to the second STA over a TDLS link established between the first STA and the second STA during a TWT service period corresponding to a broadcast TWT schedule, wherein the first STA is a member of the broadcast TWT schedule; and
receiving, from the second STA, a TDLS broadcast TWT response frame indicating acceptance of the request of the TDLS broadcast TWT request frame,
wherein the second STA is expected to be in an awake state during the one or more TWT service periods corresponding to the broadcast TWT schedule until the number of TBTTs indicated by the AP.

16. The method of claim 15, wherein the number of TBTTs is indicated in a broadcast TWT persistence subfield of a broadcast TWT parameter set field corresponding to the broadcast TWT schedule in the beacon frame or the probe response frame.

17. The method of claim 15, wherein the number of TBTTs is equal to a value in the broadcast TWT persistence subfield plus 1.

18. The method of claim 15, the method further comprising:
advertising a capabilities element indicating that the first STA supports TDLS operation with broadcast TWT.

19. The method of claim 15, wherein the broadcast TWT schedule is identified by a broadcast TWT ID subfield in a TWT information extension element in the TDLS broadcast TWT request frame.

20. The method of claim 19, wherein a value of a broadcast TWT ID subfield in a TWT information extension element in the TDLS broadcast TWT response frame is identical to a value of the broadcast TWT ID subfield in the TWT information extension element in the TDLS broadcast TWT request frame.
